(19) United States
(12) Patent Application Publication
(10) Pub. No.: US 2002/0169915 A1
(43) Pub. Date: Nov. 14, 2002

(54) USB connection-detection circuitry and operation methods of the same

(76) Inventor: Wen-Jen Wu, Taip (TW)

Correspondence Address: BIRCH STEWART KOLASCH & BIRCH, PO BOX 747, FALLS CHURCH, VA, 22040-0747, US

(21) Appl. No.: 09/941,872

(22) Filed: Aug. 30, 2001

(30) Foreign Application Priority Data
May 8, 2001 (TW) 90110999

(51) Int. Cl. G06F 13/14

(52) U.S. Cl. 710/305

(57) ABSTRACT

A USB connection-detection circuitry and the operation method of the same are disclosed. The circuitry includes a transmitting circuit and a detecting circuit. The transmitting circuit contains a pair of differential signal lines, a pair of pull-down resistors and a pair of pull-up resistors wherein one pull-down resistor and one pull-up resistor are connected to the same differential signal line with their own individual switches. A power-related signal supplied by a power-supply system is received by the transmitting circuitry and transmitted through a differential signal line. Then, the power-related signal is grounded via a pull-down resistor. The detecting circuit is utilized to detect the power-related signals, which flow through the differential lines. When a device is connected to this connection-detection circuitry with a USB cable, the differential signal lines of the USB cable are connected with the differential signal lines of this circuitry. This results in the variation of the power-related signals, which are connected to the ground through the pull-down resistors originally. Therefore, by comparing the difference of the power-related signals before and after the connection, the connection-detection circuitry is able to automatically identify the mode of the device, which connects to the circuitry.

### FIELD OF THE INVENTION

This invention relates generally to a circuitry and its operating methods, more particularly to a Connection-detection circuitry and its operating methods used in a USB system.

### DESCRIPTION OF THE RELATED ART

Universal Serial Bus (USB) is a new interface proposed by several major computer manufactures to solve the inextricable problems experienced when installing and extending a conventional computer system and its peripheral equipments. Under this system, all peripherals can communicate with the host computer through the same interface, i.e., a USB bus. Moreover, one of its distinguishing features is that all USB peripherals are provided with “plug and play” function. That is to say, it is no longer a necessity to switch off the host computer or to install the drivers prior the installation or removing of such devices.

In accordance with the USB specification, each USB system is consist of three elements: a USB host, a USB inter-connection interface, and a USB device. There is only one USB host in a USB system and is often constructed within the host computer. USB devices can be classified as a USB function device and a USB hub. USB function devices are referred to computer peripheral devices such as a keyboard, a mouse or a printer, etc. and each USB function device is connected to a USB host through a USB inter-connection interface. USB hubs can expand a single connection port to be multiple connection ports and enable a plurality of USB function devices to be connected to the same USB bus.

With reference to FIG. 1, a schematic diagram is drawn to illustrate the connecting method of a USB system. As shown in the figure, a plurality of USB functional devices and USB hubs are connected to the host 10 with a tiered star topology. A root hub 11 is located at the base of the USB host 10 and provides two connection ports 12 and 13 which are used to connect a USB hub 14 or a function device 15. Each USB hub 14 provides several connection ports to which the plural USB function devices 15,17 and USB hubs 16 can be connected. In this way, a maximum of 127 function devices can be attached to a host.

When a USB device is attached to a USB hub, its presence can be detected by the USB hub automatically. The hub informs the USB host which it is connected to that a “new device” is attached to the bus. After a succession of data transmission, the USB device is then connected to the USB bus and start responding to the requests of the host computer or the user, to perform the build-in functions thereof. In order to detect the presence of new devices, a set of connection-detection circuitry built in the USB hub and the USB devices separately are utilized by the USB hub to detect the connection and removing of the USB devices.

Refer to the FIG. 2, a set of USB Connection-detection circuitry built in a conventional USB hub device (or a host) and a conventional USB device is shown in the figure. The connection-detection circuitry includes an up stream detection circuitry 200, which is constructed in the USB hub device 20 (or a host), and a down stream detection circuitry 300, which is constructed in the USB device 30.

As shown in the figure, the USB hub device 20 and the USB device 30 are connected to each other with a USB cable 40. The USB cable 40 includes four wires: two power lines 401, 402 (VCC and GND), and two differential signal lines 403, 404 (i.e., the differential signal line 403 is referred to a D+ differential signal line while the differential line 404 is referred to a D− differential signal line). One terminal of the USB cable 40 is connected to the USB hub device 20, and the other one is connected to the USB device 30. Inside the USB hub device 20, a pair of differential signal lines 203, 204 whose terminals are connected to the USB transceiver 205 which constructed in the USB hub device 20 are used to connect to the Differential signal lines 403, 404 (D+ and D−) of the USB cable 40. Further, a pair of pull-down resistor 206, 207 are constructed in the USB hub device 20, wherein the pull-down resistor 206 is connected to the differential signal line 203, and the pull-down resistor 207 is connected to the differential signal line 204. The up stream detection circuitry 200 of the USB hub device 20 is constructed by the differential signal lines 203, 204, pull-down resistors 206, 207, and a voltage detector 220. Meanwhile, a pair of differential signal lines 303, 304 are also constructed in the USB device 30 and used to connect to the differential signal lines 403, 404 (D+ and D−) of the USB cable 40. The other terminals of the differential signal lines 303 and 304 are both connected to the USB transceiver 305 of the USB device 30.

Furthermore, a pull-up resistor 308 is constructed inside the USB device 30 and connected to the differential signal line 303 when the USB device is a Full/High Speed USB device, i.e., a device whose data transmission rate is 12/480 MB per second, such as a printer or a microphone. The differential signal line 303 is then used to connect to the D+ differential signal line 403 of the USB cable 40.

On the other hand, a pull-up resistor 309 is constructed inside the USB device 30 and connected to the differential signal line 304 when the USB device 30 is a Low Speed USB device, i.e., a device whose data transmission rate is 1.5 Mb per second, such as a mouse or a keyboard. The Differential Signal Line 304 is then used to connect to the D− differential signal line 404 of the USB cable 40.

No matter it is a high speed or a low speed device, the USB device 30 is equipped with a down stream detection circuitry 300 which is constructed by the differential signals line 303, 304 and a pull-up resistor 308 or 309. The down stream detection circuitry 300 is used to connect to the up stream detection circuitry 200 via the USB cable 40 and enables the USB hub device 20 to perform the connecting or removing detection of the USB devices.

Herein below are descriptions about the operation methods of the connection-detection circuitry.

First, the differential signal lines 203, 204 which are constructed in the USB hub device 20 and used to connect to the D+ and D− differential signal lines 403, 404 are connected to a ground voltage through the pull-down resistors 206, 207 before connecting to the USB device 30.

When the USB device 30 is connected to the USB hub device 20 via the USB cable 40, a voltage of 5V is supplied from the USB hub device 20 to the USB device 30 through a VCC power line 401 within the USB cable 40. Then a voltage of 3.3V is provided to the pull-up resistor 308 or 309 by the circuitry (not shown) inside the USB device 30 utilizing the power supplied by the USB hub device 20. If the USB device is a High-Speed device, a voltage of 3.3V is provided to the pull-up resistor 308 and a potential difference is generated between the two terminals of the differential signal line 403 of the USB cable 40. The voltage level of the differential line 203 is detected by the voltage detector 220 of the USB hub device 20. Therefore, the attached device is identified by the USB hub device 20 as a High-Speed device according to the voltage change. Besides, if the USB device 30 is a Low-Speed device, a voltage of 3.3V is provided to the pull-up resistor 309 and a potential difference is generated between the two terminals of the differential signal line 404 of the USB cable 40. The voltage level of the differential line 204 is detected by the voltage detector 220 of the USB hub device 20. Therefore, the attached device is identified by the USB hub device 20 as a Low-Speed device according to the voltage change.

On the other hand, if a USB device 30 which is originally connected to the USB hub device 20 is removed from the bus, the disconnection of the USB device 30 also can be detected by the USB hub device 20 with the connection-detection circuitry.

The above descriptions are related to a connection-detection circuitry constructed in a conventional USB hub device (or host) and a conventional USB device. A drawback of the connection-detection circuitry mentioned above is that it is designed with USB standard specifications, that is, the devices which are connected to each other through the connection-detection circuitry must maintain a host-device relationship in order to fulfill the tiered star topology of a USB bus. Thus, under such circumstances, a USB function device only can be connected to a USB hub device or a USB host device and cannot be connected to another USB function device. As a result, the data transmission directly from one USB function device to another USB function device is forbidden.

### SUMMERY OF THE INVENTION

Therefore, one object of the invention is to provide a circuitry, which enables a USB device to connect to a USB device or a USB host arbitrarily.

Further, another object of the invention is to provide an operation method of the circuitry such that a USB device containing such circuitry is able to identify the device type of a USB device or a USB host to which it is connected.

According to the invention, the circuitry includes a transmitting circuit and a detecting circuit. The transmitting circuit is used to receive a first power-related signal from a power supply system, and the detection circuit is used to detect the change of the first power-related signal. The transmitting circuit includes a first differential signal line, a first pull-down resistor, and a first switching element. Therein, the first power-related signal is transmitted through the first differential signal line and is grounded via the first pull-down resistor. The first switching element is disposed between the pull-down resistor and the first differential signal line and is used to switch the connection between the first differential signal line and the first pull-down resistor.

The transmitting circuit further includes a first power line, a second switching element, a first pull-up resistor, and a third switching element. Therein, the first power line is used to transmit a second power-related signal received from the power supply system to a power line of the USB cable, and is connected to the power supply system via the second switching element. The first pull-up resistor is connected to the first differential signal line via the third switching element.

The detecting circuit of the circuitry includes a timer which is used to calculate a period of time.

In addition, the circuitry further includes a first power supply system as the power supply system for supplying a plurality of power-related signals.

According to this invention, the present invention also provides a operation method of the circuitry and the method includes the following steps: receiving a first power-related signal from a power supply system; connecting the first power-related signal to a ground voltage through a pull-down resistor; receiving a second power related signal from the power supply system when a device is connected to the circuitry with a USB cable and transmitting the second power related signal to a power line of the USB cable before a differential signal line of the USB cable is connected to a conductive line which the first power related signal is transmitted through; detecting the change of the first power related signal before and after connecting to the device; and determining whether or not to stop receiving the first and the second power related signal from the power supply system according to the change of the first power related signal detected.

Therein, when the receiving of the first and the second power related signals are stopped, a forth power related signal is supplied by the circuitry to the differential signal line of the USB cable utilizing a third power related signal if the third power related signal is received by the circuitry from the power line of the USB cable during a time period.

On the other hand, if the third power related signal is not received by the circuitry from the power line of the USB cable after the period of time, the first and second power related signal is received from the power supply system again, and the first power related signal is connected to a ground voltage through the pull-down resistor and the second power related signal is transmitted to the power line of the USB cable.

### DESCRIPTION OF PREFERRED EMBODIMENTS

What followed is the detailed descriptions of methods and preferred embodiments of the invention to achieve the above mentioned objectives.

### Manual Switch Mode

Refer to FIG. 3, a connection-detection circuitry of the first embodiment according to the present invention is shown in the figure. The Connection-detection circuitry 500 includes a pair of differential signal lines 503, 504, a pair of pull-down resistor 506, 507, a pair of pull-up resistor 508, 509, a power supply system 510, and a set of manual switching elements 511. Wherein, the differential signal line 503 is used to connect to a D+ differential signal Line 403 of a USB cable 40 while the differential signal line 504 is used to connect to a D− differential signal line 404 of the USB cable 40. The connection-detection circuitry 500 of this embodiment is a manual-switch mode circuitry.

If a USB “Devicehost” device 50 containing such connection-detection circuitry 500 is to be connected to a USB host or a USB hub device, the user can use a set of manual-switch elements 511 to set the USB Devicehost device 50 into “Device-Mode” before the connection. Under Device-Mode, the pull-down resistors 506,507 and the power supply system 510 are disconnected by the manual-switch elements 511. When the Devicehost device 50 is a High-Speed USB device, a pull-up resistor 508 is connected to a differential signal line 503 and the other pull-up resistor 509 is disconnected. On the other hand, if the Devicehost device 50 is a Low-Speed USB device, a pull-up resistor 509 is connected to differential signal line 504 and the other pull-up resistor 508 is disconnected.

When the Devicehost device 50 is connected to a USB host or a USB hub device, a voltage of 5V is supplied from the USB host/hub device to the USB Devicehost device 50 through the USB cable 40. The following detection steps are the same with those of the USB device 30 connecting to the USB hub device 20 mentioned above.

If the Devicehost device 50 is to be connected to another USB function device, the user can use the manual-switch elements 511 to set the Devicehost device 50 into “Host-Mode”. Under Host-Mode, the pull-up resistors 508,509 are disconnected by the manual-switch elements 511. Meanwhile, the pull-down resistors 506, 507 are connected to the differential signal lines 503, 504 separately and the power supply system 510 is also connected to a power line (not shown) constructed in the Devicehost device 50. Therein, the power line is used to connect to a power line 401 of the USB cable 40. When the Devicehost device 50 is connected to a USB function device, a voltage of 5V is supplied from the Devicehost device 50 to the USB function device through the USB cable 40. Then, a voltage of 3.3V is supplied to the pull-up resistor connected to the differential signal line 403 or 404 depending on the device type of the USB function device (High-Speed or Low-Speed) by utilizing the power supplied by the Devicehost device 50. A potential difference is then generated between the two terminals of the differential signal line 403 or 404. Therefore, the device type of the USB function device can be identified by the Devicehost device 50 according to the voltage change of the differential signal line 503 or 504 and the connection-detection process of these two devices is completed.

As described above, by simulating the connection-detection methods of a USB host or hub device with the Connection-detection circuitry 500, the USB Devicehost 50 is connected to a USB function device. Thus, a USB Devicehost device of the invention is able to be connected to a USB function device with the “Host-Device” relationship of USB system and processes the data transmission between these two devices by utilizing the software and firmware constructed thereof. The problems which data can not be transmitted directly from one USB device to another USB device under the standard USB specification is solved.

### Current-Detection Mode

The “Current-Detection Mode” differs from the above-mentioned “Manual-Switch Mode” in that the type of the device to which the Devicehost device is connected, i.e., a USB host/hub device or a USB function device, is identified with a current change detected by the connection-detection circuitry inside the Devicehost device automatically. It is no longer required for the user to switch the mode of the Devicehost device whose a Current-Detection Mode connection-detection circuitry before the connection.

With reference to FIG. 4a and 4b, a connection-detection circuitry 600 of the second embodiment according to the invention is shown in the figures. The connection-detection circuitry 600 includes a pair of differential signal lines 603, 604, a power line 611, a ground line 612, a pair of pull-down resistors 606, 607, a pair of pull-up resistors 608, 609, a power supply system 610, and a current-detection circuit 620. Wherein, the differential signal lines 603, 604 are used to connect to the D+ and D− differential signal line 403, 404 of the USB cable 40 ; while each of the pull-down resistors 606 and the pull-up resistor 608 is connected to the differential signal line 603 with a switching element, and each of the pull-down resistor 607 and the pull-up resistor 609 is connected to the differential line 604 with a switching element, separately. Further, a timer 621 is constructed in the current-detection circuit 620 and will be explained in details later. Besides, the power supply system 610 of the connection-detection circuitry 600 can be omitted and replaced with an external power supply system.

The operation methods of Current-Detection mode are explained as follows.

First, a current source is supplied from the power supply system 610 to each of the differential signal lines 603 and 604, individually. Before any connection taking place, the currents Ip, Im transmitting through the pull-down resistors 606 and 607 are the same with the outputs of the current sources added to the differential signal lines 603, 604.

Then, refer to FIG. 4a, the connection method between a Devicehost device 60 including a Current-Detection Mode connection-detection circuitry 600 and a USB host/hub device 20 is shown in the figure. When the Devicehost device 60 is connected to a USB host 20 (or a USB hub device), the output current of the current source added to the differential signal line 603 is transmitted through the pull-down resistor 606 of the Devicehost device 60 and the pull-down resistor 206 of the USB host 20; while the output current of the current source added to the differential signal lines 604 is transmitted through the pull-down resistor 607 of the Devicehost device 60 and the pull-down resistor 207 of the USB host 20. Therefore, the currents Ip, Im transmitting through the pull-down resistors 606 and 607 are decreased. Assume that the currents Ip, Im transmitting through the pull-down resistors 606, 607 before connection are both “I” and the resistance of the pull-down resistors 606, 607 are both “Rpd”, then the currents Ip and Im running through the two pull-down resistors when the two devices 60, 20 are connected can be expressed by equation (1):

Ip=Im=I×Rpd/(Rpd+Rp) equation (1)

By measuring the currents Ip, Im transmitting through the pull-down resistors 606,607, the connected device can be recognized as a USB host by the Devicehost device 60. The Devicehost device 60 is then switched into “Device-Mode” automatically. Under Device-Mode, the connection between the pull-down resistors 606, 607 and the differential signal lines 603, 604 are disconnected ; while the originally disconnected pull-up resistors 608, 609 are connected to the differential signal lines 603, 604, respectively.

Refer to FIG. 4b, the connection between a Devicehost device 60 including a Current-Detection Mode connection-detection circuitry 600 and a USB device 30 is shown in the figure. As described above, a pull-up resistor 308 is connected to a differential signal line 303 which is used to connect to the D+ differential line 403 if the USB device 30 is a High-Speed USB device. On the other hand, a pull-up resistor 309 is connected to a differential signal line 304 which is used to connect to the differential line 404 of the USB cable 40 if the USB device 30 is a Low-Speed device. Assume that the connected device 30 is a High-Speed USB device, the resistance of the pull-up resistor 308 is R_{H} and the voltage source added to the pull-up resistor 308 is V_{H}, then the current Ip transmitting through the pull-down resistor 606 can be expressed by equation (2):

Iₚ=(V_{H}+I×R_{H})/(R_{H}+Rₚ) equation (2)

On the other hand, assume that the connected device 30 is a Low-Speed USB device, the resistance of the pull-up resistor 309 is R_{L} and the voltage source added to the pull-up resistor 309 is V_{L}, then the current Im transmitting through the pull-down resistor 607 can be expressed by equation (3):

Iₘ=(V_{L}+I×R_{L})/(R_{L}+Rₚ) equation (3)

By measuring the currents Ip, Im transmitting through the pull-down resistors 606,607, the connected device can be recognized as a USB device (High-Speed or Low-Speed, respectively) by the Devicehost device 60. The Devicehost device 60 is then switched into “Host-Mode” automatically. Under Host-Mode, the pull-up resistors 608 and 609 of the connection-detection circuitry 600 are remained in a disconnection state.

Therefore, the Devicehost device 60 is able to identify the type of the device to which it is connected as a USB host or a USB device automatically by utilizing the Current-Detection Mode connection-detection circuitry 600.

### Voltage Detection Mode

Similar to Current-Detection Mode described above, it is unnecessary for the user to switch the mode of the Devicehost device under “Voltage-Detection Mode”. The difference between the two is that a voltage-change rather than a current-change is detected by a voltage-detection circuit to identify the device type of the connected device under Voltage-Detection Mode.

Refer to FIG. 5a and 5b, a connection-detection circuitry 700 of the third embodiment according to the invention is shown in the figures. The connection-detection circuitry 700 of Voltage-Detection Mode includes a pair of differential signal lines 703, 704, a power line 711, a ground line 712, a pair of pull-down resistors 706 and 707, a pair of pull-up resistors 708 and 709, a pair of up-stream resistors 701 and 702, a power supply system 710, and a voltage-detection circuit 720. Wherein, the differential signal lines 703 and 704 are used to connect to the D+ and D− differential signal lines 403 and 404 of the USB cable 40, respectively. Each of the pull-down resistor 706, the pull-up resistor 708 and the up-stream resistor 701 is connected to the differential signal line 703 with a switching element, individually. Meanwhile, each of the pull-down resistor 707, the pull-up resistor 709, and the up-stream resistor 702 is connected to the differential signal line 704 with a switching element, respectively. Furthermore, a timer 721 is constructed in the voltage-detection circuit 720 and will be explained in details later.

Instead of a current source, a voltage source V is added to the pair of up-stream resistors 701, 702 which are connected to the differential signal lines 703, 704 of the connection-detection circuitry 700. Thus, before any connection taking place, assume that the resistance of the up-stream resistors 701, 702 is Rs and the resistance of the pull-down resistors is Rp, then the voltage level Vs of the differential signal lines 703, 704 detected by the voltage-detection circuit 720 can be expressed by equation (4):

Vs=V×Rp/(Rp+Rs) equation (4)

Refer to FIG. 5a, the connection between a Devicehost device 70 including a Voltage-Detection Mode connection-detection circuitry 700 and a USB host 20 (or a USB hub device) is shown in the figure. As described above, a pair of pull-down resistors 206, 207 are connected to the differential signal lines 203, 204 inside the USB host 20. The differential signal lines 203, 204 are used to connect to the differential signal lines 403, 404 of the USB cable 40. When the Device host 70 is connected to the USB host 20, assume that the resistance of the pull-down resistors 206, 207 is Rpd, then the voltage level Vh of the differential signal lines 703, 704 detected by the voltage detection circuitry can be expressed by equation (5):

Vh=V×(Rpd×Rp)/(Rpd×Rp+Rpd×Rs+Rp×Rs) (5)

By comparing the difference of the voltage levels Vs and Vh, the connected device 20 can be recognized as a USB host by the Devicehost device 70. The Devicehost device 70 is then switched into “Device-Mode” automatically. Under Device-Mode, the connection between the pull-down resistors 706, 707 and the differential signal lines 703, 704 are disconnected; while the originally disconnected pull-up resistors 708, 709 are connected to the differential signal lines 703, 704, respectively.

Refer to FIG. 5b, the connection between a Devicehost device 70 including a Voltage-Detection Mode connection-detection circuitry 700 and a USB device 30 is shown in the figure. When the Devicehost device 70 is connected to a High-Speed USB device 30, assume that the resistance of the pull-up resistor 308 of the device is R_{H} and the voltage source added to the pull-up resistor 308 is V_{H}, then the voltage level Vd of the differential line 703 detected by the voltage-detection circuit 720 can be expressed by equation (6):

V_{d}=(V×(Rₚ×R_{H})/(Rₚ×R_{H}+Rₚ×Rₛ+R_{H}×Rₛ))+(V_{H}×(Rₚ×Rₛ)/(Rₚ×Rₛ+Rₚ×R_{H}+R_{S}×R_{H})) (6)

On the other hand, if the connected device is a Low-Speed USB device, assume that the resistance of the pull-up resistor 309 is R_{L} and the voltage source added to the pull-up resistor 309 is V_{L}, then the voltage level Vₑ of the differential signal line 704 detected by the voltage-detection circuit 720 can be expressed by equation (7):

Vₑ=(V×(Rₚ×R_{L})/(Rₚ×R_{L}+Rₚ×Rₛ+R_{L}×Rₛ)) +(V_{L}×(Rₚ×Rₛ)/(Rₚ×Rₛ+Rₚ×R_{L}+Rₛ×R_{L})) (7)

By comparing the difference of the voltage levels Vs and Vd or Ve, the connected device 30 can be recognized as a USB device by the Devicehost device 70. The Devicehost device 70 is then switched into “Host-Mode” automatically. Under Host-Mode, the pull-up resistors 708 and 709 of the connection-detection circuitry 700 are remained in a disconnection state.

Summing up the above, the three types of connection-detection circuitry are designed to solve the problems existed in the conventional USB devices that the connection and data transmission are forbidden between the USB devices. A “Devicehost” device including the connection-detection circuitry is proposed by the invention. The Devicehost device is able to switch into “Device-Mode” or “Host-Mode” in response to the type of connected device by means of “Manual-Switch Mode”, “Current-detection Mode” or “Voltage-detection Mode”. Under “Manual-Switch Mode”, it is feasible for two Devicehost devices to determine the “HostDevice” relationship and connect to each other by the manual-switch method. However, there are problems in the connection between the Devicehost devices whose “Current-detection Mode” or “Voltage-detection Mode”. Therefore, a set of logic circuit is established in these Devicehost devices to solve the problem. In cooperate with FIG. 6, the set of logic circuit is explained in detail utilizing a Devicehost device of Current-Detection Mode.

Refer to FIG. 6, the procedure of a Devicehost device of Current-detection Mode to detect the type of the connected device is illustrated in a flow chart.

First of all, when the Devicehost device is connected to a device (Step 601), as described before, a current change of the D+ or D− differential signal line is detected by the current-detection circuit constructed inside the Devicehost (Step 602). If the detected current changes from “1” to the value expressed by equation (2) or (3) then the Devicehost device is able to identify that the connected device is a High-Speed USB device or a Low-Speed USB device and switch into “Host-Mode” automatically (Step 603).

However, the detected current is in consist with the current value expressed by equation (1) when a USB host or another devicehost device is connected to the Devicehost device because either of the USB host or the devicehost device is also equipped with a pair of pull-down resistors and a power supply system which can supply a 5V voltage source. Thus, when this phenomenon is detected, the Devicehost device firstly disconnects its internal power supply system which provides the 5V voltage source, and disconnects the connection between the pull-down resistors and the differential signal lines of the connection-detection circuitry (Step 604).

After this, a timer provided within the Devicehost device is activated and a time period is randomly set by the timer (Step 605). Every time when the timer is activated, a counting down process is started with the set time period. If the Devicehost device receives a 5V voltage from the connected device during this time period (Step 606), then the Devicehost device is able to identify that the connected device is a USB host and switch into “Device-Mode” automatically (Step 607).

On the other hand, if the Devicehost device does not receive a 5V voltage when the counting down process is terminated, that is, the set time period is exceeded, then the power supply system of the Devicehost device is reactivated and the pull-down resistors are connected to the differential signal lines again (Step 608). After this, as illustrated in the flow chart, the Connection-detection circuitry of the Devicehost device restarts the current-detection process from Step 602 and the above process is repeated (Step 609).

When the above detection process is proceeded within two Devicehost devices which are connected to each other, it is the “time difference” between the time periods set by the timers of the devices that determines the “Host-device” relationship. That is, when one Devicehost device has reactivated its power supply system and reconnected the pull-down resistors to the differential signal lines; while the other Devicehost device has not yet proceed to the re-connection step, the former one is recognized as a USB host and switches into “Host-Mode” (Step 602 to Step 603) and the later one is recognized as a USB device and switches into “Device-Mode” (Step 606 to Step 607).

Therefore, by the above process, the Devicehost device of the invention can accurately identify the type of the connected device and switch into “Device-Mode” or “Host-Mode” automatically in response to the connected device and to proceed the data transmission process.

While there have been shown and described what are at present considered the preferred embodiments of the present invention, it will be obvious to those skilled in the art that various changes and modifications may be made therein without departing from the scope of the invention as defined by the appended claims.

### BRIEF DESCRIPTION OF THE DRAWINGS

FIG. 1 is a schematic diagram which illustrates the connection method of a USB system.

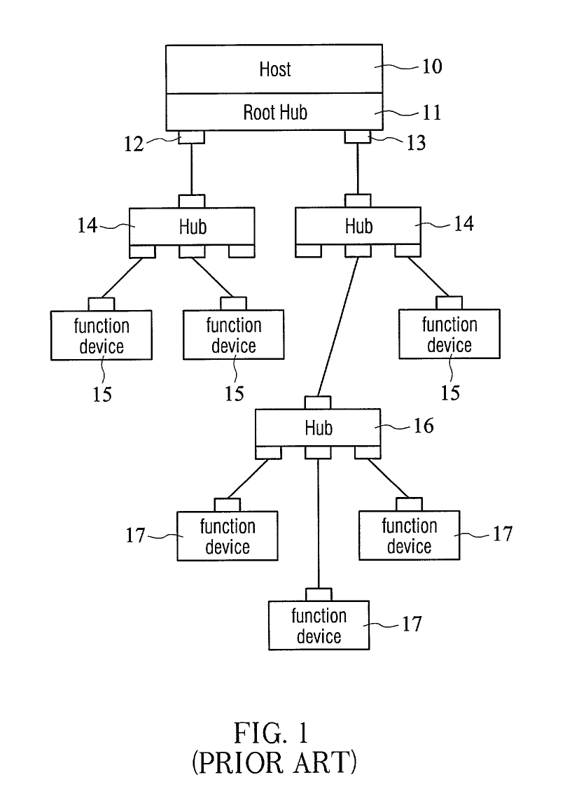

FIG. 2 is a schematic diagram of a conventional USB Connection-Detection Circuitry.

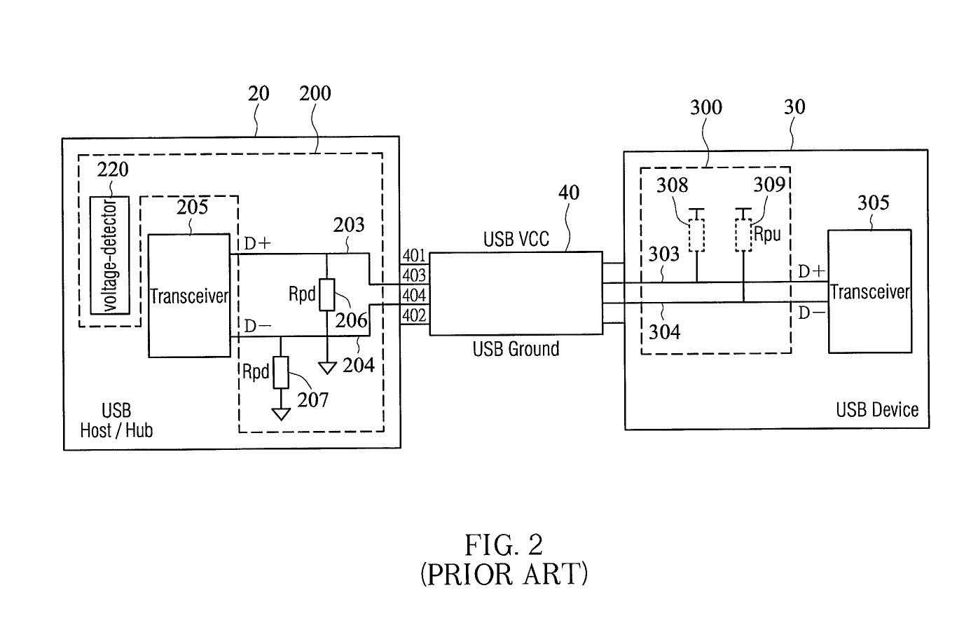

FIG. 3 is a schematic diagram of a Connection-detection circuitry of the first embodiment according to the present invention.

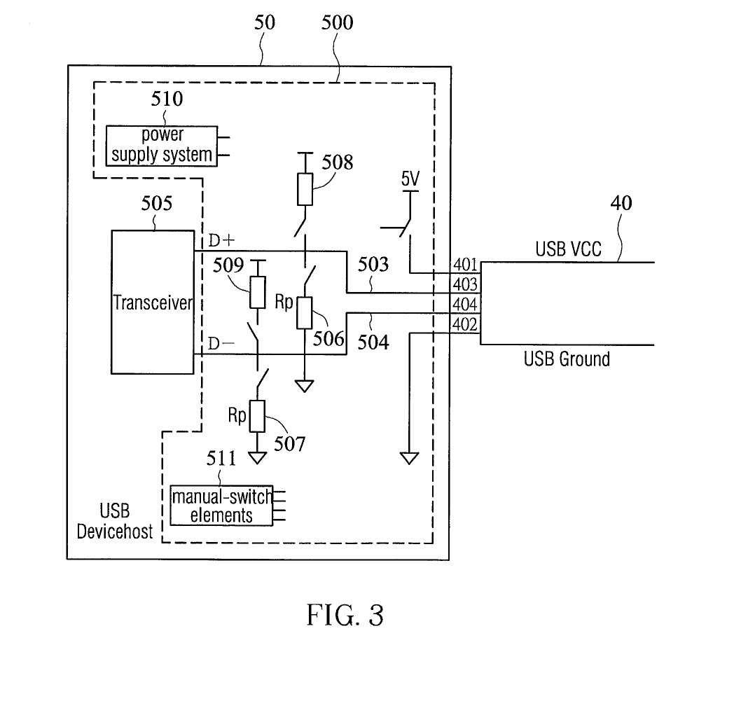

FIG. 4a is a schematic diagram illustrating the connection between a device containing a Connection-detection circuitry of the second embodiment according to the present invention and a USB host/hub device.

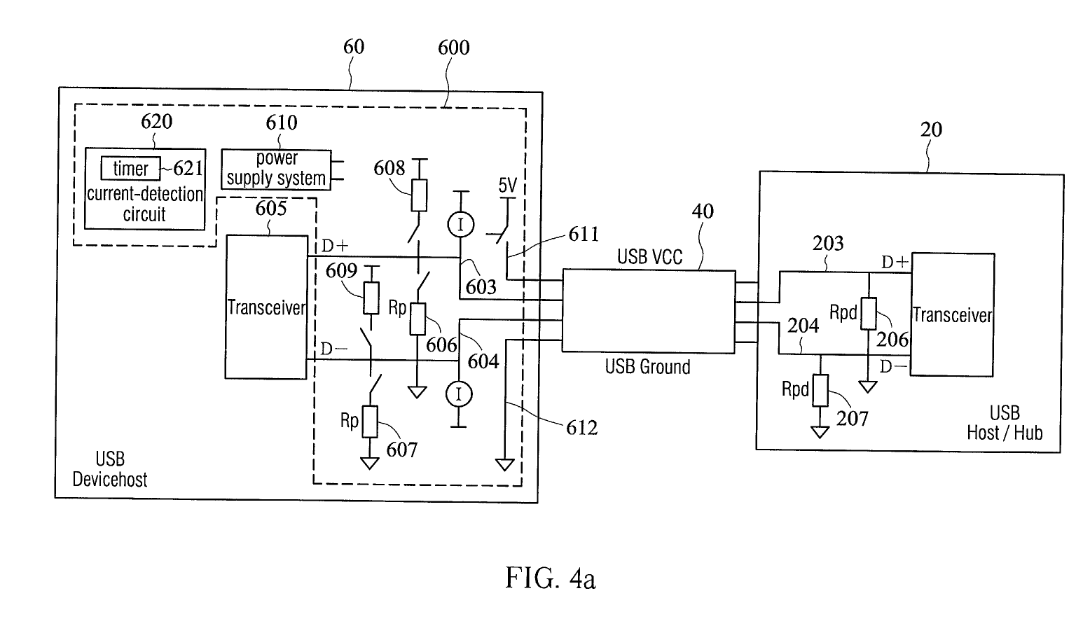

FIG. 4b is a schematic diagram illustrating the connection between a device containing a Connection-detection circuitry of the second embodiment according to the present invention and a USB device.

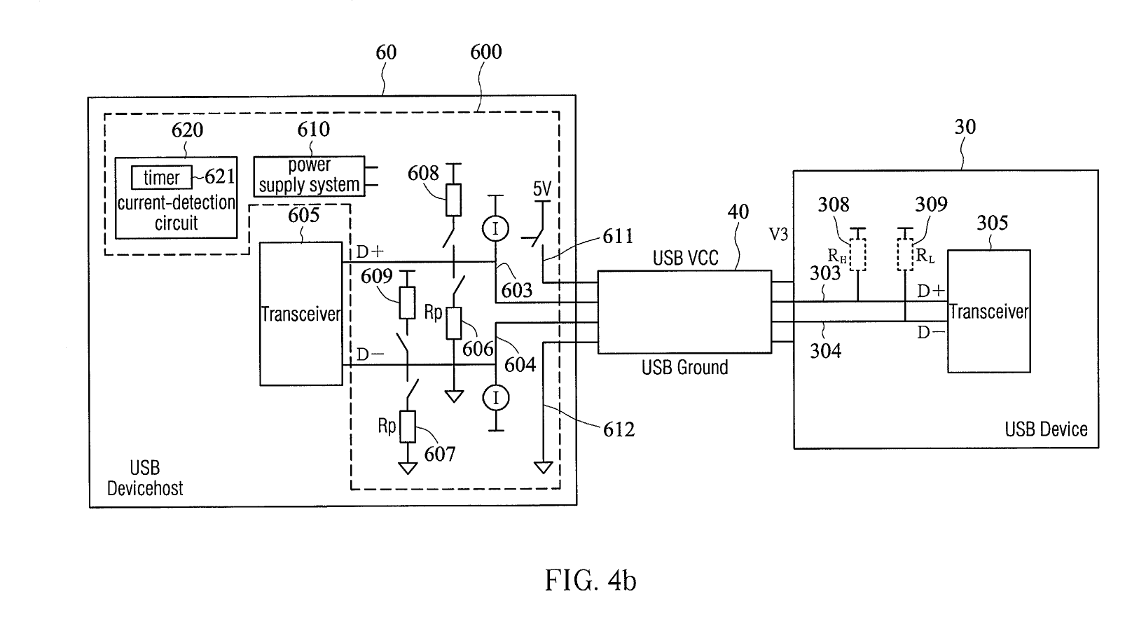

FIG. 5a is a schematic diagram illustrating the connection between a device containing a Connection-detection circuitry of the third embodiment according to the present invention and a USB host/hub device.

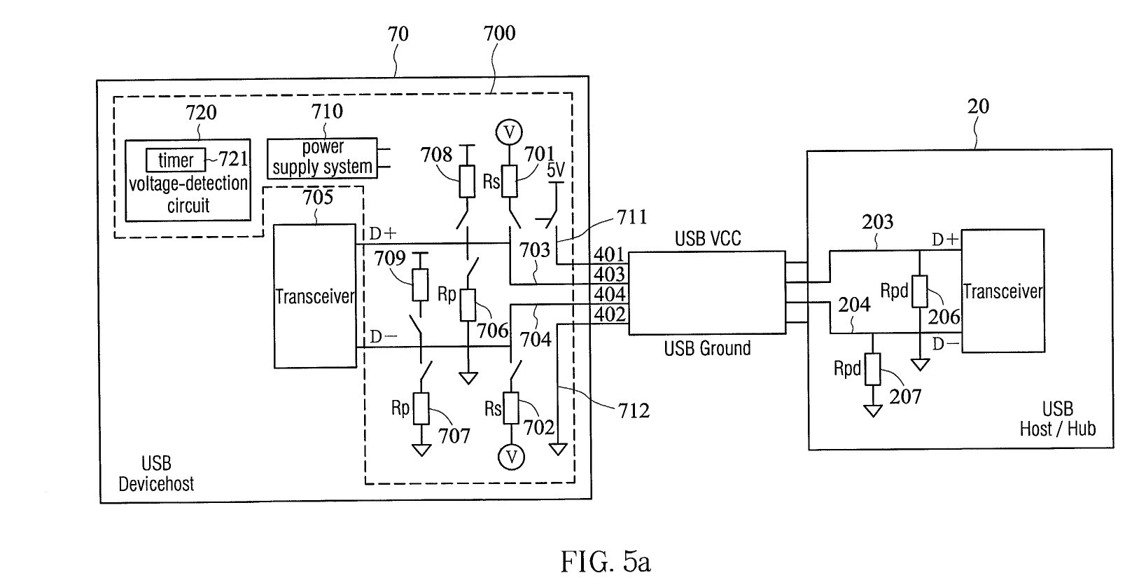

FIG. 5b is a schematic diagram illustrating the connection between a device containing a Connection-detection circuitry of the second embodiment according to the present invention and a USB device.

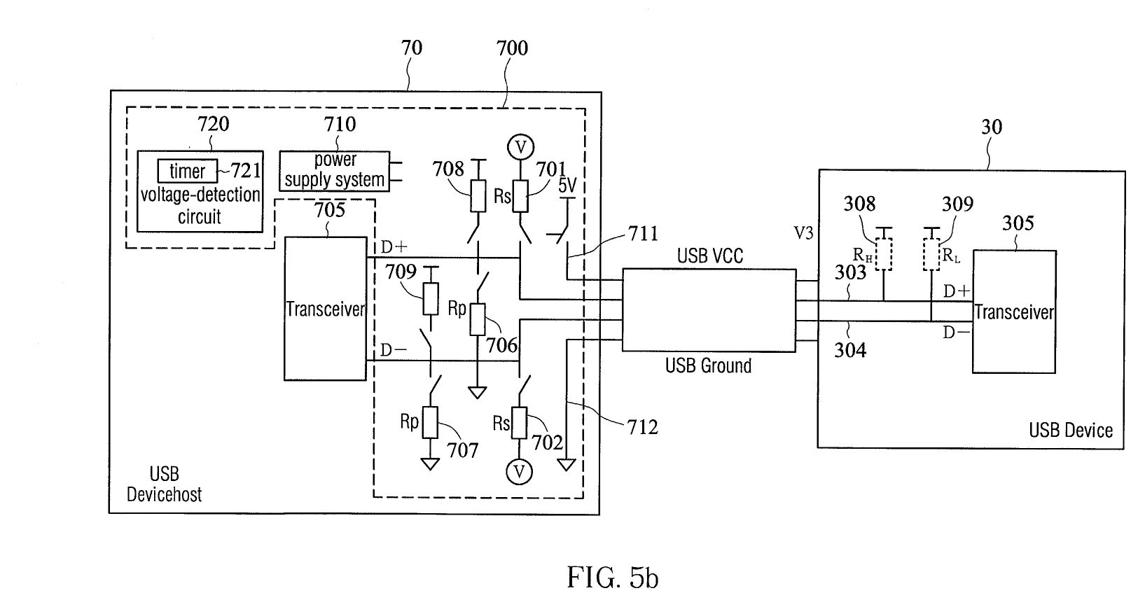

FIG. 6 is a flow chart illustrating the detection steps of the connection-detection circuitry of the second embodiment according to the present invention.

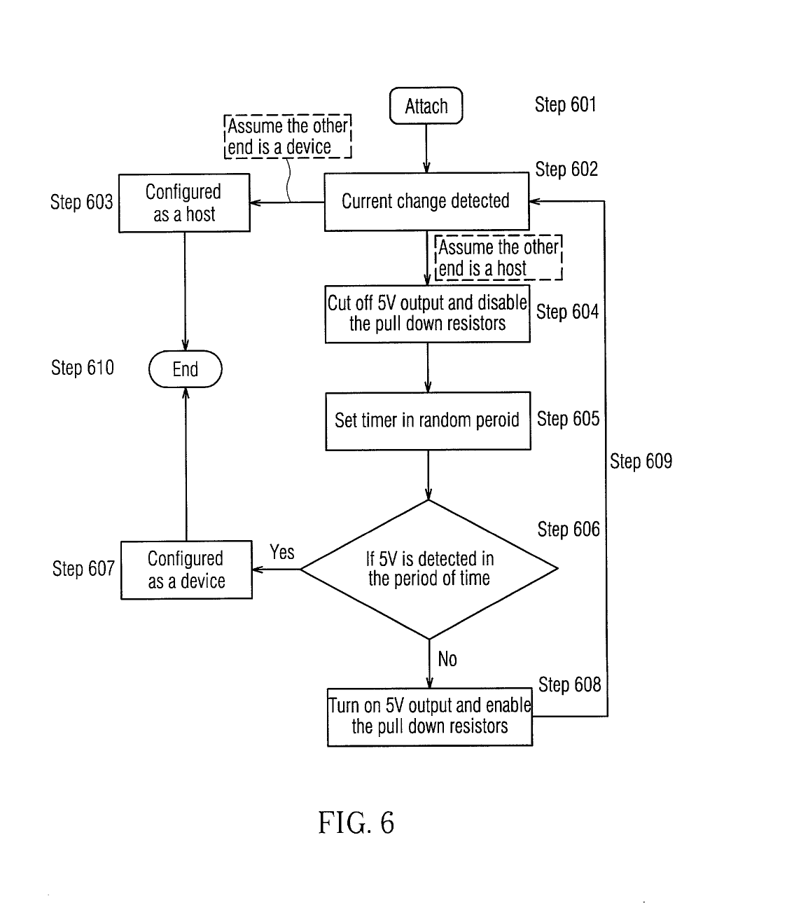

### NOTATION OF THE DRAWINGS

10 USB host

11 root hub

12 connection port

13 connection port

14 USB hub

15 USB function device

16 USB hub

17 USB function device

20 USB host/hub device

200 Up Stream Detection Circuitry

203 differential signal line

204 differential signal line

205 USB transceiver

206 pull-down resistor

207 pull-down resistor

220 voltage detector

30 USB device

300 down stream detection circuitry

303 differential signal line

304 differential signal line

305 USB transceiver

308 pull-up resistor

309 pull-up resistor

40 USB cable

401 VCC power line

402 GND power line

403 d+ differential signal line

404 d− differential signal line

50 USB devicehost

503 differential signal line

504 differential signal line

505 USB transceiver

506 pull-down resistor

507 pull-down resistor

508 pull-up resistor

509 pull-up resistor

510 power supply system

511 manual-switch elements

60 USB devicehost

600 connection-detection circuitry

603 differential signal line

604 differential signal line

605 USB transceiver

606 pull-down resistor

607 pull-down resistor

608 pull-up resistor

609 pull-up resistor

610 power supply system

611 power line

612 ground line

620 current-detection circuit

621 timer

70 USB devicehost

700 connection-detection circuitry

701 up-stream resistor

702 up-stream resistor

703 differential signal line

704 differential signal line

705 USB transceiver

706 pull-down resistor

707 pull-down resistor

710 power supply system

711 power line

712 ground line

720 voltage-detection circuit

721 timer

What is claimed is:

1. An operating method of a circuitry, comprising the following steps:
receiving a first power-related signal from a power supply system;
connecting said first power-related signal to a ground voltage through a pull-down resistor; and
detecting the change of said first power related signal when a device is connected to a conductive line which said first power related signal is transmitted through, therein, the device is connected to the circuitry with a USB cable and a differential signal line of the USB cable is connected to said conductive line.

2. The operating method of claim 1, wherein, the method further comprising:
receiving a second power related signal from said power supply system and transmitting the second power related signal to a power line of the USB cable before the differential signal line of the USB cable connecting to said conductive line; and
determining whether or not to stop receiving said first and said second power
related signal from said power supply system according to the change of said first
power related signal detected.

3. The operating method of claim 2, wherein, when the receiving of said first and said second power related signal are stopped, the method further comprising the following steps:
supplying a forth power related signal to the differential signal line of said USB cable by the circuitry utilizing a third power related signal if said third power related signal is received by the circuitry received from the power line of said USB cable during a time period.

4. The operating method of claim 3, wherein, the method further comprising:
receiving said first and said second power related signal from said power supply system again, and connecting said first power related signal to a ground voltage through said pull-down resistor and transmitting said second power related signal to the power line of said USB cable if said third power related signal is not received by the circuitry from the power line of said USB cable after said period of time.

5. The operating method of claim 4, wherein, said first power related signal is a current or a voltage.

6. The operating method of claim 5, wherein, said second power-related signal is a current or a voltage.

7. The operating method of claim 6, wherein, said third power-related signal is a current or a voltage.

8. A circuitry, which is used to connect to a USB interface, comprising:
a transmitting circuit, which is used to receive a plurality of power-related signals including a first power-related signal from a power supply system, said transmitting circuit comprising:
a first differential signal line, which is used to connect to a differential signal line of a USB cable;
a first pull-down resistor, which is used to connect to said first differential signal line, therein, said first power-related signal is transmitted through said first differential signal line and is grounded via said first Pulldown resistor; and
a first switching element, which is used to switch the connection between said first pull-down resistor and said first differential signal line; and
a detecting circuit, which is used to detect the change of said first power-related signal.

9. The circuitry of claim 8, wherein, said transmitting circuit further comprising:
a first power line, which is used to transmit a second power-related signal received from said power supply system to a power line of said USB cable;
a second switching element, which is used to switch the connection between said first power line and said power supply system;
a first pull-up resistor, which is used to connect to said first differential signal line; and
a third switching element, which is used to switch the connection between said first pull-up resistor and said first differential signal line.

10. The circuitry of claim 9, wherein, said detecting circuit further comprising:
a timer, which is used to calculate a time period.

11. The circuitry of claim 10, wherein, said circuitry further comprising:
a first power supply system, which is utilized as said power supply system which provides said plurality of power-related signals.

12. The circuitry of claim 9, wherein, said first power-related signal is a current, said second power-related signal is a voltage, and said transmitting circuit further comprising:
a second differential signal line, which is used to connect to another differential signal line of said USB cable;
a second pull-down resistor, which is used to connect to said second differential signal line, therein, another current received from said power supply system is transmitted through said second differential signal line and is grounded via said second pull-down resistor;
a forth switching element, which is used to switch the connection between said second pull-down resistor and said second differential signal line;
a second pull-up resistor, which is used to connect to the said second differential signal line; and
a fifth switching element, which is used to switch the connection between said second pull-up resistor and said second differential signal line.

13. The circuitry of claim 9, wherein, each of said first power-related signal and said second power related signal is a voltage, and said transmitting circuit further comprising:
a first resistor, which said first power-related signal is applied to and is disposed between said power supply system and said first differential signal line.

14. The circuitry of claim 13, wherein, said transmitting circuit further comprising:
a second differential signal line, which is used to connect to another differential signal line of said USB cable;
a second resistor, which is disposed between said power supply system and said second differential signal line, therein, another voltage source received by said transmitting circuit from said power supply system is applied to said second resistor;
a third switching element, which is used to switch the connection between of said second resistor element and said second differential signal line;
a second pull-down resistor, which is used to connect to said second differential signal line, therein, said another voltage source is grounded via said second pull-down resistor;
a forth switching element, which is used to switch the connection between of said second pull-down resistor device and said second differential signal line;
a second pull-up resistor, which is used to connect to said second differential signal line; and
a fifth switching element, which is used to switch the connection between said second pull-up resistor and said second differential signal line.

15. A circuitry, which is used to connect to a USB interface, comprising:
a first differential signal line, which is used to connect to a differential signal line of a USB cable;
a first resistor, whose one terminal is used to connect to a current source or a voltage source and the other terminal is used to connect to said first differential signal line;
a second resistor, whose one terminal is used to connect to said first differential signal line and the other terminal is used to connect to a ground voltage;
a first power line, whose one terminal is used to connect to a power supply system and the other terminal is used to connect to a power line of said USB cable; and
a set of switching elements, which is used to switch the connection of said first resistor and said second resistor between said first differential signal line and is used to switch the connection between said first power line and said power supply system.

16. The circuitry of claim 15, wherein, the circuitry further comprising:
a first power supply system, which is used as said power supply system connecting to said first power line.

17. A USB peripheral device, comprising:
a transmitting circuit, which is used to receive a plurality of power-related signals including a first power-related signal from a power supply system, said transmitting circuit comprising:
a first differential signal line, which is used to connect to a differential signal line of a USB cable;
a first pull-down resistor, which is used to connect to said first differential signal line, therein, said first power-related signal is transmitted through said first differential signal line and is grounded via said first Pull-down resistor; and
a first switching element, which is used to switch the connection between said first pull-down resistor and said first differential signal line; and
a detecting circuit, which is used to detect the change of said first power-related signal.

18. The USB peripheral device of claim 17, wherein the said transmitting circuit further comprising:
a first power line, which is used to transmit a second power-related signal received from said power supply system to a power line of said USB cable;
a second switching element, which is used to switch the connection between said first power line and said power supply system;
a first pull-up resistor, which is used to connect to said first differential signal line; and
a third switching element, which is used to switch the connection between said first pull-up resistor and said first differential signal line.

19. The circuitry of claim 18, wherein, said detecting circuit further comprising:
a timer, which is used to calculate a time period.

20. The circuitry of claim 19, wherein, said circuitry further comprising:
a first power supply system, which is utilized as said power supply system which provides said plurality of power-related signals.
